(19) United States
(12) Patent Application Publication
(10) Pub. No.: US 2021/0049561 A1
(43) Pub. Date: Feb. 18, 2021

(54) TRANSACTION PROCESSING METHOD AND DEVICE, ELECTRONIC DEVICE AND COMPUTER-READABLE STORAGE MEDIUM

(71) Applicant: ADVANCED NEW TECHNOLOGIES CO., LTD., Grand Cayman (KY)

(72) Inventor: Qi LI, HANGZHOU (CN)

(21) Appl. No.: 17/086,305

(22) Filed: Oct. 30, 2020

Related U.S. Application Data
(63) Continuation of application No. PCT/CN2019/100916, filed on Aug. 16, 2019.

(30) Foreign Application Priority Data
Sep. 29, 2018 (CN) 201811152495.4

(51) Int. Cl. G06Q 20/02; G06Q 20/40; G06Q 20/38; G06Q 40/02; G06F 16/23

(52) U.S. Cl. CPC G06Q 20/02; G06Q 20/40; G06Q 20/085; G06Q 40/025; G06F 16/2379; G06Q 20/389

(57) ABSTRACT

Methods, apparatuses, and devices for processing a transaction, including computer programs encoded on computer storage media are provided. One of the methods includes: generating a first transaction order based on transaction operation information from a first transaction party, accumulating first transaction orders generated in a predetermined period of time to generate a second transaction order; sending, in response to the first transaction party failing to pay for the second transaction order, data of the second transaction order to a second transaction party to pay for the second transaction order; generating a third transaction order based on the data of the second transaction order; making a payment to the transaction platform according to the third transaction order; in response to completing the payment, generating a fourth transaction order based on the third transaction order; and sending data of the fourth transaction order to the first transaction party for payment.

### CROSS-REFERENCE TO RELATED APPLICATIONS

The present application is a continuation application of International Application No. PCT/CN2019/100916, filed on Aug. 16, 2019, which claims priority and the benefit of the Chinese Patent Application No. 201811152495.4 filed with China National Intellectual Property Administration (CNIPA) of the People's Republic of China on Sep. 29, 2018. The entire contents of the above-recognized applications are incorporated herein by reference.

### TECHNICAL FIELD

Embodiments of the specification relate to the processing of transactions and, in particular, to a method, an apparatus, an electronic device and a computer-readable storage medium for processing a transaction.

### BACKGROUND

Advancements in data technology have given rise to many products for transaction and payment. Like credit card businesses, many platforms are providing users with credit payment services. Specifically, when paying for an order, a user can choose a service to fulfill the payment by a platform, and then pay a required amount back to the platform within a specified subsequent date range. While such services can provide users with increased convenience in payment and additional funding options, many potential risks are also brought to the platforms. For example, failure or refusal of users to pay off the required amounts within the respective specified time periods will lead to increases in the number of ineffective transaction operations and reductions in transaction data processing efficiency.

### SUMMARY

The embodiments of the specification provide a method, an apparatus, an electronic device and a computer-readable storage medium for processing a transaction.

In a first aspect, the embodiments of the specification provide a method for processing a transaction. The method comprises: generating a first transaction order based on transaction operation information sent from a first transaction party; accumulating one or more first transaction orders generated in a predetermined period of time to generate a second transaction order; and sending, in response to receiving information that the first transaction party fails to pay for the second transaction order, data of the second transaction order to a second transaction party to make a payment according to the data of the second transaction order.

In some embodiments, the generating a first transaction order based on transaction operation information sent from a first transaction party comprises: obtaining transaction authorization information associated with the first transaction party and a third transaction party; receiving the transaction operation information sent from the first transaction party, wherein the transaction operation information is transaction operation information between the first and third transaction parties; and generating the first transaction order based on the transaction operation information.

In some other embodiments, the accumulating one or more first transaction orders generated in a predetermined period of time to generate a second transaction order comprises: obtaining first transaction party information and first transaction amount information from each of the one or more first transaction orders generated in the predetermined period of time; accumulating the first transaction amount information to obtain total transaction amount information; and generating the second transaction order based on the first transaction party information and the total transaction amount information.

In still other embodiments, the method further comprises: updating an order status of the second transaction order in response to receiving information that the first transaction party has successfully paid for the second transaction order.

In a second aspect, the embodiments of the specification provide another method for processing a transaction. The method comprises: generating a third transaction order based on a second transaction order data sent from a fourth transaction party; making a payment to the fourth transaction party according to the third transaction order; and generating, in response to completing the payment to the fourth transaction party, a fourth transaction order based on the third transaction order and sending data of the fourth transaction order to a first transaction party to make a payment according to the data of the fourth transaction order.

In one embodiment, the generating a third transaction order based on a second transaction order data sent from a fourth transaction party comprises: receiving the second transaction order data sent from the fourth transaction party; obtaining fourth transaction party information and second transaction amount information from the second transaction order data; and generating the third transaction order based on the fourth transaction party information and the second transaction amount information.

In another embodiment, the generating, in response to completing the payment to the fourth transaction party, a fourth transaction order based on the third transaction order and sending data of the fourth transaction order to a first transaction party comprises: obtaining first transaction party information and second transaction amount information from the third transaction order; generating the fourth transaction order based on the first transaction party information and the second transaction amount information; and sending the fourth transaction order to the first transaction party.

In yet another embodiment, the method further comprises: updating an order status of the fourth transaction order in response to receiving a message from the first transaction party that the payment of the fourth transaction order is completed; and performing a predetermined operation in response to receiving a message from the first transaction party that the payment of the fourth transaction order is not completed.

In a third aspect, the embodiments of the specification provide an apparatus for processing a transaction. The apparatus comprises: a first generation module configured to generate a first transaction order based on transaction operation information sent from a first transaction party; an accumulation module configured to accumulate one or more first transaction orders generated in a predetermined period of time to generate a second transaction order; and a transmission module configured to send, in response to receiving information that the first transaction party fails to pay for the second transaction order, data of the second transaction order to a second transaction party to make a payment according to the data of the second transaction order.

In some embodiments, the generation module comprises: a first acquisition sub-module configured to obtain transaction authorization information associated with the first transaction party and a third transaction party; a first reception sub-module configured to receive the transaction operation information sent from the first transaction party, wherein the transaction operation information is transaction operation information between the first and third transaction parties; and a first generation sub-module configured to generate the first transaction order based on the transaction operation information.

In some other embodiments, the accumulation module comprises: a second acquisition sub-module configured to obtain first transaction party information and first transaction amount information from each of the one or more first transaction orders generated in the predetermined period of time; an accumulation sub-module configured to accumulate the first transaction amount information to obtain total transaction amount information; and a second generation sub-module configured to generate the second transaction order based on the first transaction party information and the total transaction amount information.

In still some other embodiments, the apparatus further comprises: a first updating module configured to update an order status of the second transaction order in response to receiving information that the first transaction party has successfully paid for the second transaction order.

In a fourth aspect, the embodiments of the specification provide another apparatus for processing a transaction. The apparatus comprises: a second generation module configured to generate a third transaction order based on second transaction order data sent from a fourth transaction party; a payment module configured to make a payment to the fourth transaction party according to the third transaction order; and a third generation module configured to generate, in response to completing the payment to the fourth transaction party, a fourth transaction order based on the third transaction order and send data of the fourth transaction order to a first transaction party to make a payment according to the data of the fourth transaction order.

In some embodiments, the second generation module comprises: a second reception sub-module configured to receive the second transaction order data sent from the fourth transaction party; a third acquisition sub-module configured to obtain fourth transaction party information and second transaction amount information from the second transaction order data; and a third generation sub-module configured to generate the third transaction order based on the fourth transaction party information and the second transaction amount information.

In some other embodiments, the third generation module comprises: a fourth acquisition sub-module configured to obtain first transaction party information and second transaction amount information from the third transaction order; a fourth generation sub-module configured to generate the fourth transaction order based on the first transaction party information and the second transaction amount information; and a transmission sub-module configured to send the fourth transaction order to the first transaction party.

In still some other embodiments, the apparatus further comprises: a second updating module configured to update an order status of the fourth transaction order in response to receiving a message from the first transaction party that the payment of the fourth transaction order is completed, and perform a predetermined operation in response to receiving a message from the first transaction party that the payment of the fourth transaction order is not completed.

In a fifth aspect, the embodiments of the specification provide an electronic device comprising a memory device and a processor. The memory device is configured to store one or more computer instructions that support the apparatuses as defined above in carrying out the respective methods in the first and second aspects. The processor is configured to execute the computer instructions stored on the memory device. Each of the apparatuses may further comprise a communication interface allowing it to communicate with other equipment or a communication network.

In a sixth aspect, the embodiments of the specification provide a computer-readable storage medium storing thereon computer instructions for use by the above apparatuses to carry out the respective transaction processing methods in the first and second aspects.

In another aspect, the specification provides a method for processing a transaction. The method may include: generating, by a transaction platform, a first transaction order based on transaction operation information from a first transaction party, wherein the first transaction order includes the transaction between the first transaction party and a third transaction party; accumulating, by the transaction platform, one or more first transaction orders generated in a predetermined period of time to generate a second transaction order; sending, by the transaction platform, in response to the first transaction party failing to pay for the second transaction order, data of the second transaction order to a second transaction party to request the second transaction party to pay for the second transaction order according to the data of the second transaction order; generating, by the second transaction party, a third transaction order based on the data of the second transaction order from the transaction platform; making a payment, by the second transaction party, to the transaction platform according to the third transaction order; generating, by the second transaction party, in response to completing the payment to the transaction platform, a fourth transaction order based on the third transaction order; and sending, by the second transaction party, data of the fourth transaction order to the first transaction party to request the first transaction party to pay for the fourth transaction order according to the data of the fourth transaction order.

In yet another aspect, the specification provides an apparatus for processing a transaction. The apparatus may include one or more processors and a non-transitory computer-readable memory coupled to the one or more processors and configured with instructions executable by the one or more processors to perform operations. The operations may include: generating, by a transaction platform, a first transaction order based on transaction operation information from a first transaction party, wherein the first transaction order includes the transaction between the first transaction party and a third transaction party; accumulating, by the transaction platform, one or more first transaction orders generated in a predetermined period of time to generate a second transaction order; sending, by the transaction platform, in response to the first transaction party failing to pay for the second transaction order, data of the second transaction order to a second transaction party to request the second transaction party to pay for the second transaction order according to the data of the second transaction order; generating, by the second transaction party, a third transaction order based on the data of the second transaction order from the transaction platform; making a payment, by the second transaction party, to the transaction platform according to the third transaction order; generating, by the second transaction party, in response to completing the payment to the transaction platform, a fourth transaction order based on the third transaction order; and sending, by the second transaction party, data of the fourth transaction order to the first transaction party to request the first transaction party to pay for the fourth transaction order according to the data of the fourth transaction order.

In still another aspect, the specification provides a non-transitory computer-readable storage medium for processing a transaction. The non-transitory computer-readable storage may store instructions executable by one or more processors to cause the one or more processors to perform operations. The operations may include: generating, by a transaction platform, a first transaction order based on transaction operation information from a first transaction party, wherein the first transaction order includes the transaction between the first transaction party and a third transaction party; accumulating, by the transaction platform, one or more first transaction orders generated in a predetermined period of time to generate a second transaction order; sending, by the transaction platform, in response to the first transaction party failing to pay for the second transaction order, data of the second transaction order to a second transaction party to request the second transaction party to pay for the second transaction order according to the data of the second transaction order; generating, by the second transaction party, a third transaction order based on the data of the second transaction order from the transaction platform; making a payment, by the second transaction party, to the transaction platform according to the third transaction order; generating, by the second transaction party, in response to completing the payment to the transaction platform, a fourth transaction order based on the third transaction order; and sending, by the second transaction party, data of the fourth transaction order to the first transaction party to request the first transaction party to pay for the fourth transaction order according to the data of the fourth transaction order.

Embodiments of the specification provide the following benefits. The above technical solution sets up another transaction party in addition to both transaction parties and the platform, and transfers the transaction in which the user fails to pay off the on-behalf payment paid by the platform to the another transaction party for subsequent processing. This technical solution not only can provide users with flexibility in transaction continuity and further provide transaction convenience for them, but also enhance transaction operation effectiveness and improve transaction data processing efficiency.

It is to be understood that both the above general description and the following detailed description are only exemplary and illustrative and do not limit embodiments of the specification.

### BRIEF DESCRIPTION OF THE DRAWINGS

With reference to the accompanying drawings, through the following detailed description of the non-limiting implementation manners, other features, objects and advantages of embodiments of the specification will become clearer. In the accompanying drawings:

FIG. 1 is a flowchart of a method for processing a transaction according to an embodiment of the specification.

FIG. 2 is a flowchart of step S101 in the method for processing a transaction according to the embodiment of FIG. 1.

FIG. 3 is a flowchart of step S102 in the method for processing a transaction according to the embodiment of FIG. 1.

FIG. 4 is a flowchart of a method for processing a transaction according to another embodiment of the specification.

FIG. 5 is a flowchart of a method for processing a transaction according to still another embodiment of the specification.

FIG. 6 is a flowchart of step S501 in the method for processing a transaction according to the embodiment of FIG. 5.

FIG. 7 is a flowchart of step S503 in the method for processing a transaction according to the embodiment of FIG. 5.

FIG. 8 is a flowchart of a method for processing a transaction according to yet still another embodiment of the specification.

FIG. 9 is a block diagram of an apparatus for processing a transaction according to an embodiment of the specification.

FIG. 10 is a block diagram of a first generation module 901 in the apparatus for processing a transaction according to the embodiment of FIG. 9.

FIG. 11 is a block diagram of an accumulation module 902 in the apparatus for processing a transaction according to the embodiment of FIG. 9.

FIG. 12 is a block diagram of an apparatus for processing a transaction according to another embodiment of the specification.

FIG. 13 is a block diagram of an apparatus for processing a transaction according to still another embodiment of the specification.

FIG. 14 is a block diagram of a second generation module 1301 in the apparatus for processing a transaction according to the embodiment of FIG. 13.

FIG. 15 is a block diagram of a third generation module 1303 in the apparatus for processing a transaction according to the embodiment of FIG. 13.

FIG. 16 is a block diagram of an apparatus for processing a transaction according to yet still another embodiment of the specification.

FIG. 17 is a block diagram of an electronic device according to an embodiment of the specification.

FIG. 18 is a structural schematic of a computer system for implementing a method for processing a transaction according to an embodiment of the specification.

### DETAILED DESCRIPTION

Embodiments of the specification will be described below in detail with reference to the accompanying drawings so that those skilled in the art can readily practice them. In addition, for clarity, parts not related to the embodiments are omitted in the drawings.

In embodiments of the specification, it is to be understood that the terms such as “including”, “having,” or the like are intended to indicate the existence of the features, numbers, steps, actions, components, parts, or combinations thereof disclosed herein and are not intended to preclude the possibility that one or more other features, numbers, steps, actions, components, parts, or combinations thereof may exist or may be added.

Additionally, it is to be noted that, whenever there is no conflict, embodiments of the specification and features thereof can be combined with one another in any combination. Embodiments of the specification will be described by way of specific examples with reference to the accompanying drawings.

The embodiments of specification set up another transaction party in addition to both transaction parties and the platform, and transfers the transaction in which the user fails to pay off the on-behalf payment paid by the platform to the another transaction party for subsequent processing. This technical solution not only can provide users with flexibility in transaction continuity and further provide transaction convenience for them, but also enhance transaction operation effectiveness and improve transaction data processing efficiency.

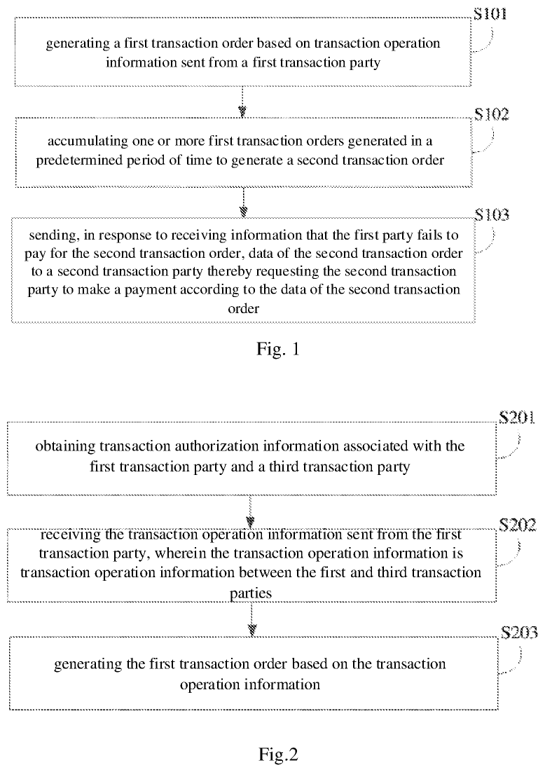

FIG. 1 is a flowchart of a method for processing a transaction according to an embodiment of the specification. The method is implementable on a platform side and, as shown in FIG. 1, includes steps S101-S103.

In step S101, generating a first transaction order based on transaction operation information sent from a first transaction party.

In step S102, accumulating one or more first transaction orders generated in a predetermined period of time to generate a second transaction order.

In step S103, sending, in response to receiving information that the first transaction party fails to pay for the second transaction order, data of the second transaction order to a second transaction party, thereby requesting the second transaction party to make a payment according to the data of the second transaction order.

As noted above, advancements in data technology have given rise to many products for transaction and payment. Like credit card businesses, many platforms are providing users with credit payment services. For example, when paying for an order, a user can choose such a service to fulfill the payment by a platform, and then pay a required amount back to the platform within a specified subsequent date range. While such services can provide users with increased convenience in payment and additional funding options, many potential risks are also brought to the platforms, for example, failure or refusal of users to pay off the required amounts within the respective specified time periods will lead to increases in the number of ineffective transaction operations and reductions in transaction data processing efficiency.

In order to overcome this problem, this embodiment proposes a method for processing a transaction, in which in addition to both transaction parties and the platform, another transaction party is involved. The transaction in which the user fails to pay off the on-behalf payment paid by the platform is transferred to the another transaction party for subsequent processing. This technical solution not only can provide users with flexibility in transaction continuity and further provide transaction convenience for them, but also enhance transaction operation effectiveness and improve transaction data processing efficiency.

The first transaction party refers to a user or buyer who transacts with a merchant or seller.

The transaction operation information may include one or more of a first transaction party ID, a first transaction party information, a transaction ID information, transaction occurrence time information, transaction details, transaction amount, transaction status, transaction confirmation information, etc.

With similarity to the transaction operation information, the first transaction order may also include one or more of the following pieces of information: the first transaction party ID, first transaction party information, transaction ID information, transaction occurrence time information, transaction details, transaction amount, transaction status, transaction confirmation information, etc.

The second transaction order is an order generated by accumulating the one or more first transaction orders generated within the predetermined period of time. In some embodiments, upon the generation of any first transaction order, the platform will immediately make the payment to the merchant on behalf of the user. Therefore, the second transaction order may be regarded herein as a bill for the predetermined period of time addressed to the user, which specifies an accrued amount that the user owes to the platform within the period.

Normally, the user may conduct multiple transactions with the same or different merchants, resulting in the generation of multiple transaction orders. Then a bill may be generated by accumulating such transaction orders generated within a predetermined period of time, after the bill is delivered by the platform to the user, requiring him/her to make a repayment according to the amount of the bill. However, if the user fails to do so within a designated period due to insufficient available funds, malicious arrears or other reasons (namely occurring an abnormal process), then the second transaction party is introduced to the process to make an intervention, that is, the second transaction party shall first make a payment to the platform according to data of the bill received from the platform on behalf of the user and then can seek to recover the money from the user. This technical solution not only can provide users with flexibility in transaction continuity and further provide transaction convenience for them, but also enhance transaction operation effectiveness and improve transaction data processing efficiency.

The predetermined period of time may be set, for example, as a one-week or one-month period, and its length can be determined by those skilled in the art according to the requirements of practical applications. The specification is not limited to any particular length of the period.

The second transaction party may be a transaction party similar to the platform, or a legally qualified transaction party such as an insurance company, a legal institution qualified for intervention in such transactions or the like.

In some embodiments, as shown in FIG. 2, step S101, i.e., generating a first transaction order based on transaction operation information sent from a first transaction party may include steps S201-S203.

In step S201, obtaining transaction authorization information associated with the first transaction party and a third transaction party.

In step S202, receiving the transaction operation information sent from the first transaction party, wherein the transaction operation information is transaction operation information between the first and third transaction parties.

In step S203, generating the first transaction order based on the transaction operation information.

In this implementation, to generate the first transaction order based on the transaction operation information sent from the first transaction party, the platform first obtains the transaction authorization information associated with the first transaction party and a third transaction party; and after the transaction authorization information thereof is obtained, when receiving the transaction operation information sent from the first transaction party, the platform generates the first transaction order based on a transaction operation information.

The third transaction party refers to a merchant or seller who transacts with the first transaction party.

The transaction authorization information refers to information used by both transaction parties to authorize and authenticate the platform payment operation, for example, on-behalf payment agreement, on-behalf payment authorization, on-behalf payment authentication, etc.

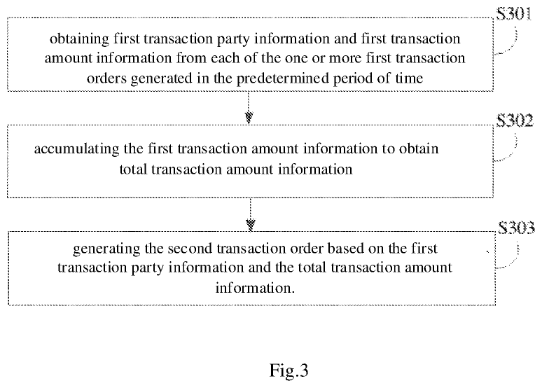

In some embodiments, as shown in FIG. 3, step S102, i.e., accumulating the one or more first transaction orders generated in a predetermined period of time to generate a second transaction order may include steps S301-S303.

In step S301, obtaining first transaction party information and first transaction amount information from each of the one or more first transaction orders generated in the predetermined period of time.

In step S302, accumulating the first transaction amount information to obtain total transaction amount information.

In step S303, generating the second transaction order based on the first transaction party information and the total transaction amount information.

In this implementation, to generate the second transaction order, the platform first obtains the first transaction party information and the first transaction amount information from each of the one or more first transaction orders generated in the predetermined period of time; then accumulates the first transaction amount information to obtain the total transaction amount information; and generates the second transaction order based on the first transaction party information and the total transaction amount information.

While the first transaction order may comprise multiple transaction orders generated between the first transaction party and a plurality of third transaction parties, since the first transaction party is the debtor of all of these transaction orders, it is possible to extract the first transaction party information as well as the corresponding transaction amount information from the first transaction order for summarization.

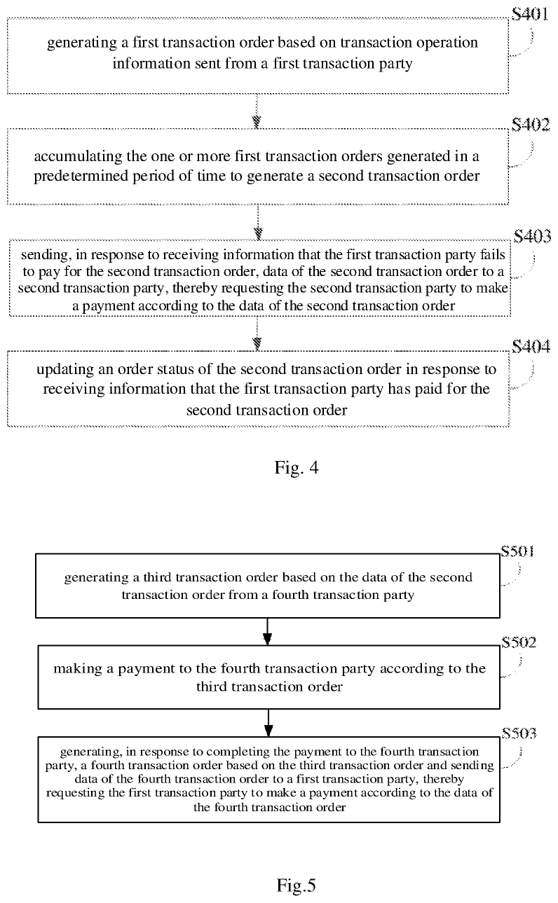

In some embodiments, the method may include: updating an order status of the second transaction order in response to receiving information that the first transaction party has paid for the second transaction order, as shown in FIG. 4, may include steps S401-S404.

In step S401, generating a first transaction order based on transaction operation information sent from a first transaction party.

In step S402, accumulating one or more first transaction orders generated in a predetermined period of time to generate a second transaction order.

In step S403, sending, in response to receiving information that the first transaction party fails to pay for the second transaction order, data of the second transaction order to a second transaction party, thereby requesting the second transaction party to make a payment according to the data of the second transaction order.

In step S404, updating an order status of the second transaction order in response to receiving information that the first transaction party has paid for the second transaction order.

In this implementation, if the first transaction party fails to pay for the second transaction order, then data of the second transaction order are sent to the second transaction party, thereby requesting the second transaction party to make a payment according to the data of the second transaction order on behalf of the first transaction party. However, if the first transaction party succeeds in paying for the second transaction order, it is considered that the transaction between the first transaction party and the platform has been normally completed. In this case, on-behalf payment by the second transaction party is not necessary, and the order status of the second transaction order is updated to “Completed”.

FIG. 5 is a flowchart of a method for processing a transaction according to another embodiment of the specification, implementable by a second transaction party. As shown in FIG. 5, the method includes steps S501-S503.

In step S501, generating a third transaction order based on a second transaction order data sent from a fourth transaction party.

In step S502, making a payment to the fourth transaction party according to the third transaction order.

In step S503, generating, in response to completing the payment to the fourth transaction party, a fourth transaction order based on the third transaction order and sending data of the fourth transaction order to a first transaction party, thereby requesting the first transaction party to make a payment according to the data of the fourth transaction order.

In this embodiment, a method for processing a transaction is provided, setting up another transaction party in addition to both transaction parties and the platform, and transferring the transaction in which the user fails to pay off the on-behalf payment paid by the platform to the another transaction party for subsequent processing. This technical solution not only can provide users with flexibility in transaction continuity and further provide transaction convenience for them, but also enhance transaction operation effectiveness and improve transaction data processing efficiency.

The fourth transaction party refers to the platform who pays on behalf of the first transaction party (e.g., a user) to a merchant and receive a repayment made by the second transaction party on behalf of the first transaction party (e.g., a user).

The third transaction order refers to a transaction order generated for making a repayment to the fourth transaction party on behalf of the first transaction party (e.g., a user).

The fourth transaction order refers to a transaction order generated for recovering the on-behalf repayment from the first transaction party (e.g., a user).

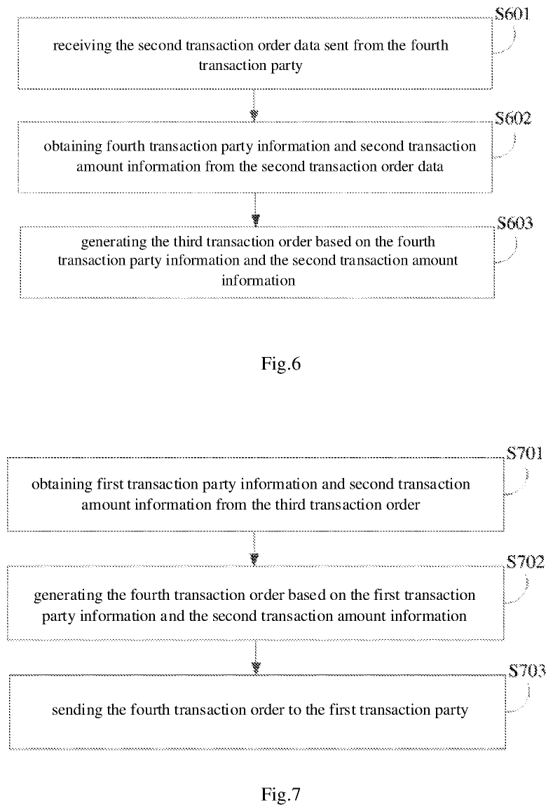

In some embodiments, as shown in FIG. 6, step S501, i.e., the generating a third transaction order based on a second transaction order data sent from a fourth transaction party, may include steps S601-S603.

In step S601, receiving the second transaction order data sent from the fourth transaction party.

In step S602, obtaining a fourth transaction party information and a second transaction amount information from the second transaction order data.

In step S603, generating the third transaction order based on the fourth transaction party information and the second transaction amount information.

In this implementation, wherein the generating a third transaction order based on a second transaction order data sent from a fourth transaction party comprises: obtaining fourth transaction party information and second transaction amount information from the second transaction order data; generating the third transaction order based on the fourth transaction party information and the second transaction amount information.

Since the third transaction order is a transaction order generated for making a repayment to the fourth transaction party on behalf of the first transaction party (e.g., a user), it is possible to obtain the fourth transaction party information and the corresponding transaction amount information from the data of the second transaction order.

In some embodiments, as shown in FIG. 7, step S503, i.e., the generating, in response to completing the payment to the fourth transaction party, a fourth transaction order based on the third transaction order and sending data of the fourth transaction order to a first transaction party may include steps S701-S703.

In step S701, obtaining first transaction party information and second transaction amount information from the third transaction order.

In step S702, generating the fourth transaction order based on the first transaction party information and the second transaction amount information.

In step S703, sending the fourth transaction order to the first transaction party.

In this implementation, following the completion of the payment to the fourth transaction party, the payment recovery process to the first transaction party can be performed, that is, generating a fourth transaction order based on the third transaction order and sending data of the fourth transaction order to a first transaction party. For example, a first transaction party information and a second transaction amount information from the third transaction order are obtained first, then the fourth transaction order based on the first transaction party information and the second transaction amount information can be generated; and the fourth transaction order can be sent to the first transaction party, thereby requesting the first transaction party to repay the amount that has been paid on behalf thereof.

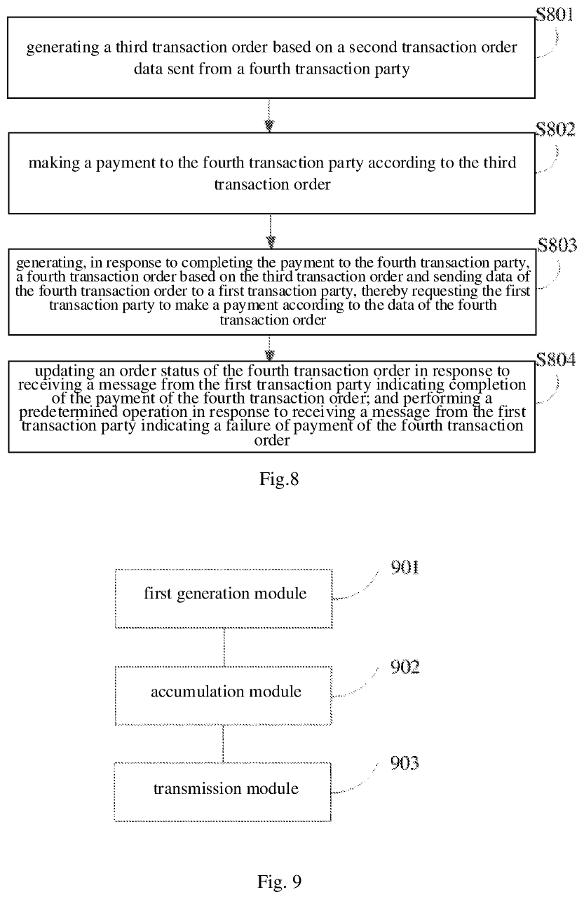

In some embodiments, the method may further include performing corresponding operation based on payment status of the fourth transaction order by the first transaction party. As shown in FIG. 8, the method may include steps S801-S804.

In step S801, generating a third transaction order based on a second transaction order data sent from a fourth transaction party.

In step S802, making a payment to the fourth transaction party according to the third transaction order.

In step S803, generating, in response to completing the payment to the fourth transaction party, a fourth transaction order based on the third transaction order and sending data of the fourth transaction order to a first transaction party, thereby requesting the first transaction party to make a payment according to the data of the fourth transaction order.

In step S804, updating an order status of the fourth transaction order in response to receiving a message from the first transaction party indicating completion of the payment of the fourth transaction order; and performing a predetermined operation in response to receiving a message from the first transaction party indicating a failure of payment of the fourth transaction order.

In this implementation, if the first transaction party succeeds in paying for the fourth transaction order, it is considered that the transaction between the first and second transaction parties has been normally completed. In this case, the order status of the fourth transaction order is updated to “Completed”. However, if the first transaction party fails to pay for the fourth transaction order, it is considered that an abnormality has occurred in the payment process, and the predetermined operation is performed. The predetermined operation may include one or more of following operations: setting a time limit for payment, lowering a social credit value of the first transaction party, triggering a penalty procedure, raising the amount that should be paid, etc.

Apparatus embodiments for carrying out the above-described method embodiments will be described below.

FIG. 9 is a block diagram of an apparatus for processing a transaction according to an embodiment of the specification. The apparatus may be implemented as an electronic device or part thereof, and in particular as a platform-side apparatus, by software, hardware or any combination of both. As shown in FIG. 9, the apparatus includes:

a first generation module 901 configured to generate a first transaction order based on transaction operation information sent from a first transaction party;

an accumulation module 902 configured to accumulate one or more first transaction orders generated in a predetermined period of time to generate a second transaction order; and

a transmission module 903 configured to send, in response to receiving an information that the first transaction party fails to pay for the second transaction order, data of the second transaction order to a second transaction party to make a payment according to the data of the second transaction order.

As noted above, advancements in data technology have given rise to many products for transaction and payment. Like credit card businesses, many platforms are providing users with credit payment services. For example, when paying for an order, a user can choose such a service to fulfill the payment by a platform, and then pay a required amount back to the platform within a specified subsequent date range. While such services can provide users with increased convenience in payment and additional funding options, many potential risks to the platforms will also be brought, for example, failure or refusal of users to pay off the required amounts within the respective specified time periods will lead to increases in the number of ineffective transaction operations and reductions in transaction data processing efficiency.

In order to overcome this problem, in some embodiments, an apparatus for processing a transaction is provided. The apparatus involves another transaction party in addition to both transaction parties and the platform, and transfers the transaction that the user fails to pay on behalf of the platform to the another transaction party for subsequent processing. This technical solution not only can provide users with flexibility in transaction continuity and further provide transaction convenience for them, but also enhance transaction operation effectiveness and improve transaction data processing efficiency.

The first transaction party refers to a user or buyer who transacts with a merchant or seller.

The transaction operation information may include one or more of a first transaction party ID, a first transaction party information, a transaction ID information, a transaction occurrence time information, transaction details, transaction amount, transaction status, transaction confirmation information, etc.

With similarity to the transaction operation information, the first transaction orders may also include one or more of the following pieces of information: the first transaction party ID, a first transaction party information, a transaction ID information, transaction occurrence time information, transaction details, transaction amount, transaction status, transaction confirmation information, etc.

The second transaction order is an order generated by accumulating the first transaction orders generated within the predetermined period of time. In some embodiments, upon the generation of any first transaction order, the platform will immediately make the payment to the merchant on behalf of the user. Therefore, the second transaction order may be regarded herein as a bill for the predetermined period of time addressed to the user, which specifies an accrued amount that the user owes to the platform within the period.

Normally, the user may conduct multiple transactions with the same or different merchants, resulting in the generation of multiple transaction orders. Such transaction orders generated within a predetermined period of time may be accumulated in a bill, which is then delivered by the platform to the user, requiring him/her to repay the amount. However, if the user fails to do so within a designated period due to insufficient available funds, malicious arrears or other reasons (namely abnormal process occurs), the second transaction party is introduced to this process to make an intervention, that is, the second transaction party shall first make a payment to the platform according to data of the bill received from the platform on behalf of the user and then can seek to recover the money from the user. This not only can provide users with flexibility in transaction continuity and further provide transaction convenience for them, but also enhance transaction operation effectiveness and improve transaction data processing efficiency.

The predetermined period of time may be set, for example, as a one-week or one-month period, and its length can be determined by those skilled in the art according to the requirements of practical applications. This specification is not limited to any particular length of the period.

The second transaction party may be a transaction party similar to the platform, or a legally qualified transaction party such as an insurance company, a legal institution qualified for intervention in such transactions or the like.

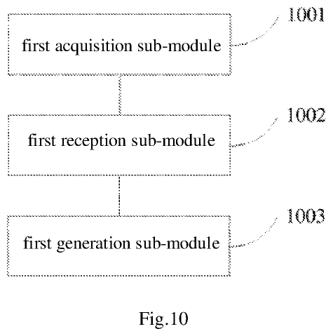

In some embodiments, as shown in FIG. 10, the first generation module 901 may include:

a first acquisition sub-module 1001 configured to obtain transaction authorization information associated with the first transaction party and a third transaction party;

a first reception sub-module 1002 configured to receive the transaction operation information sent from the first transaction party, wherein the transaction operation information is transaction operation information between the first and third transaction parties; and

a first generation sub-module 1003 configured to generate the first transaction order based on the transaction operation information.

In this implementation, generating a first transaction order based on the transaction operation information sent from a first transaction part by the first generation module 901 may include: obtaining, by a first acquisition sub-module 1001, transaction authorization information associated with the first transaction party and a third transaction party; after obtaining the transaction authorization information thereof, when a first reception sub-module 1002 receives the transaction operation information sent from the first transaction party, generating, by a first generation sub-module 1003, the first transaction order based on the transaction operation information.

The third transaction party refers to a merchant or seller who transacts with the first transaction party.

The transaction authorization information refers to information used by both transaction parties to authorize and authenticate the platform payment operations, for example, on-behalf payment agreement, on-behalf payment authorization, on-behalf payment authentication, etc.

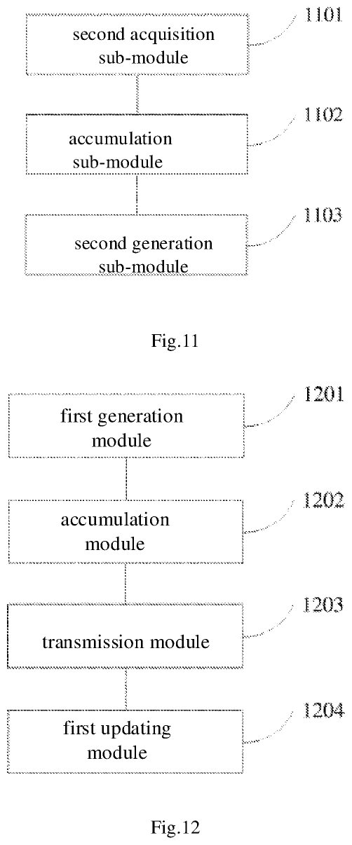

In some embodiments, as shown in FIG. 11, the accumulation module 902 may include:

a second acquisition sub-module 1101 configured to obtain first transaction party information and first transaction amount information from each of the one or more first transaction orders generated in the predetermined period of time;

an accumulation sub-module 1102 configured to accumulate the first transaction amount information to obtain total transaction amount information;

a second generation sub-module 1103 configured to generate the second transaction order based on the first transaction party information and the total transaction amount information.

In this implementation, generating the accumulated second transaction order by the accumulation module 902 may include: obtaining, by a second acquisition sub-module 1101, first transaction party information and first transaction amount information from each first transaction order generated in the predetermined period of time; accumulating, by an accumulation sub-module 1102, the first transaction amount information to obtain total transaction amount information; and generating, by a second generation sub-module 1103 the second transaction order based on the first transaction party information and the total transaction amount information.

While the first transaction order may comprise multiple transaction orders generated between the first transaction party and a plurality of third transaction parties, since the first transaction party is the debtor of all of them, it is possible to extract the first transaction party information as well as the corresponding transaction amount information from the first transaction orders for summarization.

In some embodiments, the apparatus may be also configured to: update an order status of the second transaction order if the first transaction party succeeds in paying for the second transaction order. As shown in FIG. 12, the apparatus may include:

a first generation module 1201 configured to generate a first transaction order based on transaction operation information sent from a first transaction party;

an accumulation module 1202 configured to accumulate the one or more first transaction orders generated in a predetermined period of time to generate a second transaction order;

a transmission module 1203 configured to send, in response to receiving information that the first transaction party fails to pay for the second transaction order, data of the second transaction order to a second transaction party, thereby requesting the second transaction party to make a payment according to the data of the second transaction order; and

a first updating module 1204 configured to update an order status of the second transaction order in response to receiving information that the first transaction party has paid for the second transaction order.

In this implementation, if the first transaction party fails to pay for the second transaction order, then the second transaction order data are sent to the second transaction party, requiring the second transaction party to make a payment according to the second transaction party data on behalf of the first transaction party. However, if the first transaction party succeeds in paying for the second transaction order, it is considered that the transaction between the first transaction party and the platform has been normally completed. In this case, on-behalf payment by the second transaction party is not necessary, and the order status of the second transaction order is updated to “Completed”.

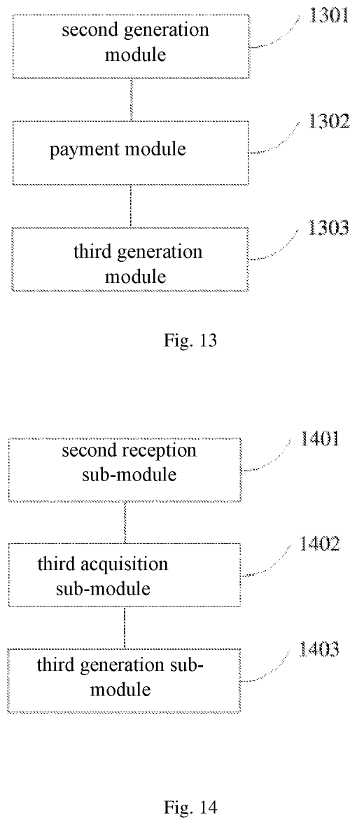

FIG. 13 is a block diagram of an apparatus for processing a transaction according to another embodiment of the specification. The apparatus may be implemented as an electronic device or part thereof, and in particular as a second transaction party-side apparatus, by software, hardware or any combination of both. As shown in FIG. 13, the apparatus includes:

a second generation module 1301 configured to generate a third transaction order based on a second transaction order data sent from a fourth transaction party;

a payment module 1302 configured to make a payment to the fourth transaction party according to the third transaction order; and

a third generation module 1303 configured to generate, in response to completing the payment to the fourth transaction party, a fourth transaction order based on the third transaction order and send data of the fourth transaction order to a first transaction party, thereby requesting the first transaction party to make a payment according to the data of the fourth transaction order.

In this embodiment, an apparatus for processing a transaction is provided, in which involves another transaction party in addition to both transaction parties and the platform, and transfers the transaction in which the user fails to pay off the on-behalf payment paid by the platform to the another transaction party for subsequent processing. This apparatus not only can provide users with flexibility in transaction continuity and further provide transaction convenience for them, but also enhance transaction operation effectiveness and improve transaction data processing efficiency.

The fourth transaction party refers to the platform who pays on behalf of the first transaction party (e.g., a user) to a merchant and receive a repayment made by the second transaction party on behalf of the first transaction party (e.g., a user).

The third transaction order refers to a transaction order generated for making a repayment to the fourth transaction party on behalf of the first transaction party (e.g., a user).

The fourth transaction order refers to a transaction order generated for recovering the on-behalf repayment from the first transaction party (e.g., a user).

In some embodiments, as shown in FIG. 14, the second generation module 1301 may include:

a second reception sub-module 1401 configured to receive the second transaction order data sent from the fourth transaction party;

a third acquisition sub-module 1402 configured to obtain fourth transaction party information and second transaction amount information from the second transaction order data; and

a third generation sub-module 1403 configured to generate the third transaction order based on the fourth transaction party information and the second transaction amount information.

In this embodiment, generating a third transaction order based on the second transaction order data sent from the fourth transaction party by the second generation module 1301 may include: obtaining, by a third acquisition sub-module 1402, fourth transaction party information and second transaction amount information from the second transaction order data and; generating, by a third generation sub-module 1403, the third transaction order based on the fourth transaction party information and the second transaction amount information.

Since the third transaction order is a transaction order generated for making a repayment to the fourth transaction party on behalf of the first transaction party (e.g., a user), it is possible to obtain the fourth transaction party information and the corresponding transaction amount information from the second transaction order data.

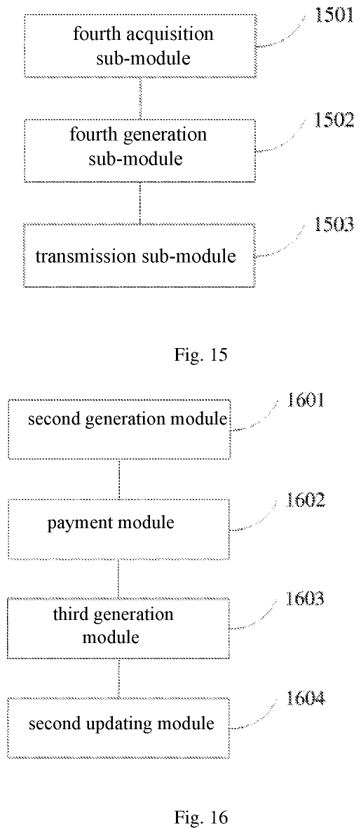

In some embodiments, as shown in FIG. 15, the third generation module 1303 may include:

a fourth acquisition sub-module 1501 configured to obtain first transaction party information and second transaction amount information from the third transaction order;

a fourth generation sub-module 1502 configured to generate the fourth transaction order based on the first transaction party information and the second transaction amount information; and

a transmission sub-module 1503 configured to send the fourth transaction order to the first transaction party.

In this implementation, following the completion of the payment to the fourth transaction party, the payment recovery process to the first transaction party can be performed, that is, generating a fourth transaction order based on the third transaction order and sending data of the fourth transaction order to a first transaction party. For example, a fourth acquisition sub-module 1501 obtains first transaction party information and a second transaction amount information from the third transaction order; a fourth generation sub-module 1502 generates the fourth transaction order based on the first transaction party information and the second transaction amount information; and a transmission sub-module 1503 sends the fourth transaction order to the first transaction party, thereby requesting the first transaction party to make a payment for the on-behalf payment according to the fourth transaction order.

In some embodiments, the apparatus may further include performing an operation depending on whether the first transaction party has paid for the fourth transaction order. In this case, as shown in FIG. 16, the apparatus may include:

a second generation module 1601 configured to generate a third transaction order based on a second transaction order data sent from a fourth transaction party;

a payment module 1602 configured to make a payment to the fourth transaction party according to the third transaction order;

a third generation module 1603 configured to generate, in response to completing the payment to the fourth transaction party, a fourth transaction order based on the third transaction order and send data of the fourth transaction order to a first transaction party, thereby requesting the first transaction party to make a payment according to the data of the fourth transaction order; and

a second updating module 1604 configured to update an order status of the fourth transaction order in response to receiving a message from the first transaction party indicating completion of payment of the fourth transaction order, and perform a predetermined operation in response to receiving a message from the first transaction party indicating a failure of payment of the fourth transaction order.

In this implementation, if the first transaction party succeeds in paying for the fourth transaction order, it is considered that the transaction between the first and second transaction parties has been normally completed. In this case, the order status of the fourth transaction order is updated to “Completed”. However, if the first transaction party fails to pay for the fourth transaction order, it is considered that an abnormality has occurred in the payment process, and the predetermined operation is performed. The predetermined operation may include one or more of following operations: setting a time limit for payment, lowering a social credit value of the first transaction party, triggering a penalty procedure, raising the amount that should be paid, etc.

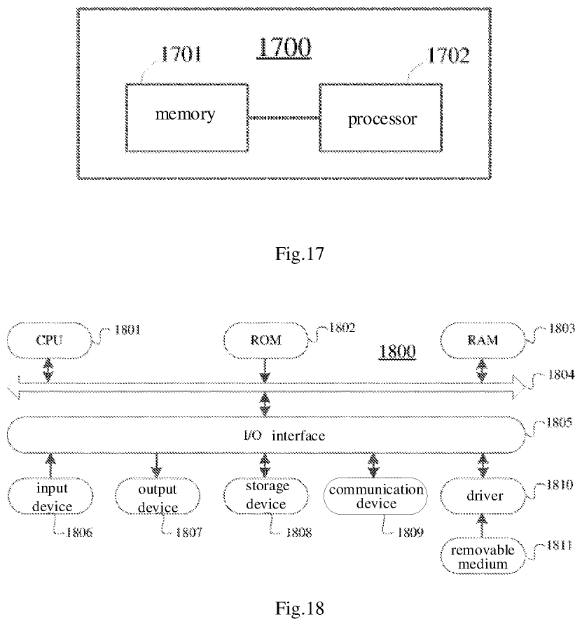

In embodiments of the specification, an electronic device is provided. FIG. 17 is a block diagram of the electronic device according to an embodiment of the specification. As shown in FIG. 17, the electronic device 1700 includes a memory 1701 and a processor 1702.

The memory 1701 is configured to store one or more computer instructions, wherein upon execution of the one or more computer instructions by the processor, the steps as defined in any one of the above method is implemented.

FIG. 18 is a structural schematic of a computer system for implementing a method for processing a transaction according to an embodiment of the specification.

As shown in FIG. 18, the computer system 1800 includes a central processing unit (CPU) 1801 that is able to perform the various processes as described in the foregoing embodiments according to programs stored on a read-only memory (ROM) 1802 or programs loaded from storage device 1808 into a random access memory (RAM) 1803. The RAM 1803 may store various program and data necessary for operations of the system 1800. The CPU 1801, the ROM 1802 and the RAM 1803 are connected to one another by a bus 1804. An input/output (I/O) interface 1805 is also connected to the bus 1804.

The following components are connected to the I/O interface 1805: input device 1806 including a keyboard, a mouse, etc.; output device 1807 including a cathode ray tube (CRT) or a liquid crystal display (LCD), a speaker, etc.; the storage device 1808 including a hard disc drive; and communication device 1809 including a network interface card such as a LAN card, a modem, etc. The communication device 1809 is configured for communications via a network such as the Internet. A driver 1810 may also be connected to the I/O interface 1805 as needed. A removable medium 1811 such as a magnetic disk, an optical disk, a magneto-optical disk, a semiconductor storage or the like may be installed on the driver 1810 so that a computer program may be read therefrom and installed on the storage device 1808 as needed.

In particular, according to embodiments of the specification, any of the methods described above may be implemented as a computer software program. For example, embodiments of the specification include a computer program product comprising a computer program that is tangibly embodied on a readable medium thereof and includes program codes for executing the method for processing a transaction. In such embodiments, the computer program may be downloaded and installed from a network via the communication device 1809 and, and/or installed from the removable medium 1811.

The flowcharts and block diagrams in the figures illustrate the architecture, functionality and operation of possible implementations of systems, methods, and computer program products according to various embodiments of the specification. In this regard, each block in the flowcharts or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, can be implemented by special purpose hardware-based systems that perform the specified functions or acts or carry out combinations of special purpose hardware and computer instructions.

Related units or modules described in embodiments of the specification may be implemented by either software or hardware. The described units or modules may also be provided in a processor and, in some circumstances, their nomenclature does not limit the units or modules themselves.

As another aspect, there is also provided, in embodiments of the specification, a computer-readable storage medium, which may either be included in any of the apparatuses of the foregoing embodiments, or stand-alone from the apparatuses. The computer-readable storage medium stores thereon one or more programs, which can be executed by one or more the above-described processors to carry out the methods described in embodiments of the specification.

Presented above are merely some embodiments of the specification and the principles thereof. It is to be understood by those skilled in the art that the scope of embodiments of the specification is not limited to the particular combinations of the above features and is intended to also include any other combination of the above features or equivalents thereof that does not depart from the concept of the invention. For example, without limitation, the above features may interchange with features functionally similar to those disclosed in embodiments of the specification.

1. A method for processing a transaction, comprising:
generating, by a transaction platform, a first transaction order based on transaction operation information from a first transaction party, wherein the first transaction order includes a transaction between the first transaction party and a third transaction party;
accumulating, by the transaction platform, one or more first transaction orders generated in a predetermined period of time to generate a second transaction order;
sending, by the transaction platform, in response to the first transaction party failing to pay for the second transaction order, data of the second transaction order to a second transaction party to request the second transaction party to pay for the second transaction order according to the data of the second transaction order;
generating, by the second transaction party, a third transaction order based on the data of the second transaction order from the transaction platform;
making a payment, by the second transaction party, to the transaction platform according to the third transaction order;
generating, by the second transaction party, in response to completing the payment to the transaction platform, a fourth transaction order based on the third transaction order; and
sending, by the second transaction party, data of the fourth transaction order to the first transaction party to pay for the fourth transaction order according to the data of the fourth transaction order.

2. The method of claim 1, wherein generating the first transaction order based on the transaction operation information from the first transaction party comprises:
in response to obtaining transaction authorization information associated with the first transaction party and the third transaction party and receiving the transaction operation information from the first transaction party,
generating the first transaction order based on the transaction operation information.

3. The method of claim 1, wherein the accumulating the one or more first transaction orders generated in a predetermined period of time to generate the second transaction order comprises:
obtaining first transaction party information and first transaction amount information from each of the one or more first transaction orders generated in the predetermined period of time;
accumulating the first transaction amount information to obtain total transaction amount information; and
generating the second transaction order based on the first transaction party information and the total transaction amount information.

4. The method of claim 1, further comprising:
updating, by the transaction platform, an order status of the second transaction order in response to the first transaction party paying for the second transaction order.

5. The method according to claim 1, wherein generating the third transaction order based on the data of the second transaction order from transaction platform comprises:
receiving the second transaction order data from the transaction platform;
obtaining transaction platform information and the second transaction amount information from the second transaction order data; and
generating the third transaction order based on the transaction platform information and the second transaction amount information.

6. The method of claim 1, wherein generating the fourth transaction order based on the third transaction order comprises:
obtaining first transaction party information and second transaction amount information from the third transaction order; and
generating the fourth transaction order based on the first transaction party information and the second transaction amount information.

7. The method of claim 1, further comprising:
updating, by the second transaction party, an order status of the fourth transaction order in response to the first transaction party paying for the fourth transaction order; and
performing, by the second transaction party, a predetermined operation in response to the first transaction party failing to pay for the fourth transaction order.

8. An apparatus for processing a transaction, comprising one or more processors and a non-transitory computer-readable memory coupled to the one or more processors and configured with instructions executable by the one or more processors to perform operations comprising:
generating, by a transaction platform, a first transaction order based on transaction operation information from a first transaction party, wherein the first transaction order includes the transaction between the first transaction party and a third transaction party;
accumulating, by the transaction platform, one or more first transaction orders generated in a predetermined period of time to generate a second transaction order;
sending, by the transaction platform, in response to the first transaction party failing to pay for the second transaction order, data of the second transaction order to a second transaction party to request the second transaction party to pay for the second transaction order according to the data of the second transaction order;
generating, by the second transaction party, a third transaction order based on the data of the second transaction order from the transaction platform;
making a payment, by the second transaction party, to the transaction platform according to the third transaction order;
generating, by the second transaction party, in response to completing the payment to the transaction platform, a fourth transaction order based on the third transaction order; and
sending, by the second transaction party, data of the fourth transaction order to the first transaction party to request the first transaction party to pay for the fourth transaction order according to the data of the fourth transaction order.

9. The apparatus of claim 8, wherein generating the first transaction order based on the transaction operation information from the first transaction party comprises:
in response to obtaining transaction authorization information associated with the first transaction party and the third transaction party and receiving the transaction operation information from the first transaction party,
generating the first transaction order based on the transaction operation information.

10. The apparatus of claim 8, wherein the accumulating the one or more first transaction orders generated in a predetermined period of time to generate the second transaction order comprises:
obtaining first transaction party information and first transaction amount information from each of the one or more first transaction orders generated in the predetermined period of time;
accumulating the first transaction amount information to obtain total transaction amount information; and
generating the second transaction order based on the first transaction party information and the total transaction amount information.

11. The apparatus of claim 8, wherein the operations further comprise:
updating, by the transaction platform, an order status of the second transaction order in response to the first transaction party paying for the second transaction order.

12. The apparatus of claim 8, wherein generating the third transaction order based on the data of the second transaction order from transaction platform comprises:
receiving the second transaction order data from the transaction platform;
obtaining transaction platform information and the second transaction amount information from the second transaction order data; and
generating the third transaction order based on the transaction platform information and the second transaction amount information.

13. The apparatus of claim 8, wherein generating the fourth transaction order based on the third transaction order comprises:
obtaining first transaction party information and second transaction amount information from the third transaction order; and
generating the fourth transaction order based on the first transaction party information and the second transaction amount information.

14. The apparatus of claim 8, wherein the operations further comprise:
updating, by the second transaction party, an order status of the fourth transaction order in response to the first transaction party paying for the fourth transaction order; and
performing, by the second transaction party, a predetermined operation in response to the first transaction party failing to pay for the fourth transaction order.

15. A non-transitory computer-readable storage medium for processing a transaction, storing instructions executable by one or more processors to cause the one or more processors to perform operations comprising:
generating, by a transaction platform, a first transaction order based on transaction operation information from a first transaction party, wherein the first transaction order includes the transaction between the first transaction party and a third transaction party;
accumulating, by the transaction platform, one or more first transaction orders generated in a predetermined period of time to generate a second transaction order;
sending, by the transaction platform, in response to the first transaction party failing to pay for the second transaction order, data of the second transaction order to a second transaction party to request the second transaction party to pay for the second transaction order according to the data of the second transaction order;
generating, by the second transaction party, a third transaction order based on the data of the second transaction order from the transaction platform;
making a payment, by the second transaction party, to the transaction platform according to the third transaction order;
generating, by the second transaction party, in response to completing the payment to the transaction platform, a fourth transaction order based on the third transaction order; and
sending, by the second transaction party, data of the fourth transaction order to the first transaction party to request the first transaction party to pay for the fourth transaction order according to the data of the fourth transaction order.

16. The non-transitory computer-readable storage medium of claim 15, wherein the accumulating the one or more first transaction orders generated in a predetermined period of time to generate the second transaction order comprises:
obtaining first transaction party information and first transaction amount information from each of the one or more first transaction orders generated in the predetermined period of time;
accumulating the first transaction amount information to obtain total transaction amount information; and
generating the second transaction order based on the first transaction party information and the total transaction amount information.

17. The non-transitory computer-readable storage medium of claim 15, wherein the operations further comprise:
updating, by the transaction platform, an order status of the second transaction order in response to the first transaction party paying for the second transaction order.

18. The non-transitory computer-readable storage medium of claim 15, wherein generating the third transaction order based on the data of the second transaction order from transaction platform comprises:
receiving the second transaction order data from the transaction platform;
obtaining transaction platform information and the second transaction amount information from the second transaction order data; and
generating the third transaction order based on the transaction platform information and the second transaction amount information.

19. The non-transitory computer-readable storage medium of claim 15, wherein generating the fourth transaction order based on the third transaction order comprises:
obtaining first transaction party information and second transaction amount information from the third transaction order; and
generating the fourth transaction order based on the first transaction party information and the second transaction amount information.

20. The non-transitory computer-readable storage medium of claim 15, wherein the operations further comprise:
updating, by the second transaction party, an order status of the fourth transaction order in response to the first transaction party paying for the fourth transaction order; and
performing, by the second transaction party, a predetermined operation in response to the first transaction party failing to pay for the fourth transaction order.
